(19) United States
(12) Patent Application Publication
(10) Pub. No.: US 2024/0408939 A1
(43) Pub. Date: Dec. 12, 2024

(54) FOOTWELL HEATING MODULE

(71) Applicant: Gentherm GmbH, Odelzhausen (DE)

(72) Inventor: Peter Edward Ganster, Plymouth, MI (US)

(21) Appl. No.: 18/698,683

(22) PCT Filed: Oct. 6, 2022
(86) PCT No.: PCT/IB2022/059564

§ 371 Date: Apr. 4, 2024

Related U.S. Application Data
(60) Provisional application No. 63/255,114, filed on Oct. 13, 2021.

(51) Int. Cl. B60H 1/22

(52) U.S. Cl. CPC B60H 1/2218

(57) ABSTRACT

A heating module and a vehicle and vehicle seat comprising the same. The heating module comprises a housing and a printed circuit board assembly. The housing comprises a printed circuit board assembly portion and a heating element portion. The printed circuit board assembly is located within the printed circuit board assembly portion. One or more heating elements are located within the heating element portion. An airflow is provided to the printed circuit board assembly portion by a fluid moving device to draw heat from the printed circuit board assembly.

### CROSS-REFERENCE TO RELATED APPLICATIONS

The present application is a national stage of International Application Number PCT/IB2022/059564, which claims priority to U.S. Provisional Application No. 63/255,114, both of which are incorporated herein by reference in their entireties.

### FIELD

The present teachings generally relate to a heating module. The heating module may be employed upon a vehicle seat. The heating module may be advantageous in fitting within a small packaging space and effectuate an airflow upon an occupant's legs.

### BACKGROUND

Larger automotive vehicles typically contain auxiliary HVAC units to condition the second and third row occupants. Typically, these auxiliary HVAC units rely upon conditioned liquid coolant supplied from an internal combustion engine cooling system. In order to operate under this arrangement, coolant lines run through the vehicle from the internal combustion engine cooling system to the HVAC unit. Moreover, a heater core, through which coolant flows and exchanges heat with an airflow, is located within the HVAC unit. These extra parts increase the costs and manufacturing complexity of vehicles.

Fully electric vehicles are not supplied with internal combustion engine cooling systems. Liquid-based battery cooling systems that can be employed with electric vehicles may not provide the same degree of heat to coolant as compared to internal combustion engine cooling systems. Moreover, hybrid vehicles, in which internal combustion engines are not constantly operational during driving, may not provide the same degree of heat to coolant as compared to non-hybrid internal combustion engine vehicles.

Another consideration related to liquid coolant systems is packaging space. The requirement for coolant lines and heater cores increases the packaging space of these HVAC units. By eliminating these parts, the packaging space may be reduced. Thus, HVAC units generating heat through other means is needed.

Conventional automotive vehicles are being provided with an increasing quantity of occupant comfort systems such as HVAC units. These units are located in various parts of a vehicle including dashboards, steering wheels, vehicle seats, headrests, roofs, and pillars. Each of these locations have specific packaging space requirements. Due to the size of some conventional HVAC units, fitting into these packaging spaces may be precluded. Moreover, in some applications only small volumes of airflow are required to suitably condition an occupant. One such exemplary application includes conditioning of a passenger's legs.

One alternative to liquid-cooled systems is an electrically powered heating element. Typically, these systems employ printed circuit board assemblies (“PCBAs”) to at least control the operation of a fluid moving device and heating element. PCBAs can generate heat during operation due to the current flowing therethrough and can absorb heat from surrounding structures such as heating elements or other structures that conduct heat from heating elements. As a result, the performance and useful life of the PCBAs can be diminished. With small packaging space requirements, PCBAs may need to be located proximate to heating elements, which presents a problem.

Temperature sensors are typically used to operate HVAC units. The ambient air temperature in a vehicle cabin is compared to a setpoint temperature programmed by occupants and the HVAC unit adjusts accordingly. Thus, the location of the sensor that provides the most representative measurement of ambient air temperature is an important consideration. This may be achieved by disposing the sensor in open, ambient air un-sequestered by any covering surrounding the sensor. The sensor should also be located where it cannot be damaged or at least the likelihood of damage is reduced.

It would be desirable to provide a heating module that operates without coolant so that coolant lines and a heater core, and thus extra parts, costs, and manufacturing complexity may be eliminated.

It would be desirable to provide a heating module that can be employed in hybrid and fully electric vehicles.

It would be desirable to provide a heating module with a smaller packaging space as compared to liquid-coolant-based heating modules. It would be desirable to provide a heating module that can fit underneath or within a vehicle seat. It would be desirable to provide a heating module that can effectuate an airflow upon an occupant's legs.

It would be desirable to provide a heating module with a PCBA that is protected from heat generated by a heating element. It would be desirable to provide a heating module that provides airflow and thus cooling to a PCBA.

It would be desirable to provide a heating module with an air temperature sensor that is disposed in ambient air. It would be desirable to provide a heating module with an air temperature sensor that is protected from contact and damage. It would be desirable to provide a heating module with an air temperature sensor that is not influenced by the heat produced by the heating module.

### SUMMARY

The present disclosure relates to a heating module, which may address at least some of the needs identified above. The heating module may comprise a housing and a printed circuit board assembly. The housing may comprise a printed circuit board assembly portion and a heating element portion. A printed circuit board assembly may be located within the printed circuit board assembly portion. One or more heating elements may be located within the heating element portion. The printed circuit board assembly portion may be discrete from the heating element portion.

An airflow may be provided to the printed circuit board assembly portion by a fluid moving device to draw heat from the printed circuit board assembly. The airflow provided to the printed circuit board assembly portion may be separate from an airflow provided to the heating element portion.

The housing may comprise a conduit extending between the fluid moving device and the inlet of the printed circuit board assembly portion.

The direction of the airflow expelling from an outlet of the printed circuit board assembly portion may oppose the direction of the airflow expelling from an outlet of the heating element portion.

The outlet of the printed circuit board assembly portion may be located on a first end of the heating module that opposes a second end of the heating module where the outlet of the heating element portion is located.

The printed circuit board assembly may comprise a first side and a second side in opposing relationship to one another. The first or second side may be oriented toward the fluid moving device and one or more heating elements.

The first or second side of the printed circuit board assembly may be abutting or proximate to an inner surface of the printed circuit board assembly portion that is oriented toward the fluid moving device and one or more heating elements.

The heating module may comprise an air temperature sensor for measuring ambient air in a cabin of a vehicle. A signal from the air temperature sensor may be employed to direct the speed of the fluid moving device and/or the temperature of the one or more heating elements. The air temperature sensor may be a negative temperature coefficient sensor.

The air temperature sensor may protrude from a printed circuit board assembly portion of the housing. The air temperature sensor may protrude into a space between the printed circuit board assembly portion, the heating element portion, a conduit extending between the fluid moving device and the inlet of the printed circuit board assembly portion, or any combination thereof.

The one or more heating elements may be positive temperature coefficient heating elements.

Connectors of the one or more heating elements may extend into the printed circuit board assembly portion. Wiring may extend from the connectors to the printed circuit board assembly.

The fluid moving device may be integrated into the housing.

The heating module may comprise a diffuser for diffusing an airflow expelled from an outlet of the heating element portion. The diffuser may direct an air flow in one, two, or even three directions. The diffuser may be Y-shaped. The diffuser may be structurally discrete from and couplable to the housing.

The present disclosure relates to a vehicle, which may address at least some of the needs identified above. The vehicle may comprise the heating module of the present disclosure. The vehicle may be a hybrid vehicle or fully electric vehicle.

The present disclosure relates to a vehicle seat, which may address at least some of the needs identified above. The vehicle seat may comprise the heating module of the present disclosure.

The vehicle seat may be located in a first, a second, and/or a third row of a vehicle. The heating module may be adapted to effectuate an airflow upon an occupant's legs. An inlet of the fluid moving device may be oriented downward from the vehicle seat.

The heating module may be secured to a frame of the vehicle seat. The heating module may be packaged within a cushion of the vehicle seat.

### BRIEF DESCRIPTION OF THE DRAWINGS

FIG. 1 illustrates a perspective view of a heating module according to the present disclosure.

FIG. 2 illustrates a perspective view of a heating module according to the present disclosure.

FIG. 3A illustrates an exploded view of a heating module according to the present disclosure.

FIG. 3B illustrates a plan view of a heating module according to the present disclosure.

FIG. 4 illustrates a perspective view of heating elements and heat exchangers according to the present disclosure.

FIG. 5 illustrates a perspective view of a printed circuit board assembly according to the present disclosure.

FIG. 6 illustrates a perspective view of a vehicle seat according to the present disclosure.

FIG. 7 illustrates a heating module coupled to an underside of a vehicle seat according to the present disclosure.

FIG. 8 illustrates a vehicle according to the present disclosure.

### DETAILED DESCRIPTION

The heating module of the present disclosure may be employed in a vehicle. Some of the benefits of the heating module may be realized in hybrid and/or fully electric vehicles but it is contemplated that the heating module may also be advantageous for use in internal combustion engine vehicles. The vehicles may include sedans, crossovers, sports utility vehicles, pickup trucks, trucks, mini-vans, vans, busses, construction vehicles, recreational off-highway vehicles, the like, or any combination thereof.

The vehicles may include a cabin. The cabin may be any compartment in which occupants are situated. The ambient air may be present in and/or circulate within the cabin. Ambient air, as referred to herein, may mean any air within the cabin surrounding occupants or any body parts thereof.

A fluid moving device may uptake the ambient air from the cabin. The fluid moving device may cause air to flow through a housing and/or the constituent elements thereof. The fluid moving device may cause air to flow across a PCBA. The fluid moving device may cause air to flow through or across heating elements and/or heat exchangers.

The ambient air may be conditioned. The ambient air may be conditioned by heat exchange with heating elements. The ambient air may flow through the heating module without being conditioned. The conditioned or ambient air may be delivered to a cabin of a vehicle. The conditioned or ambient air may be delivered to a footwell. Footwell, as referred to herein, may mean an area below a seating surface plane where occupants' legs are situated when the occupants are seated. The conditioned or ambient air may be delivered to an occupant. The conditioned or ambient air may be utilized to provide heat to or draw heat from an occupant. The conditioned or ambient air may be delivered to any body part of an occupant. The conditioned or ambient air may be delivered to a head, a torso, or a lower body of occupants or any combination thereof.

The vehicle may include one or more vehicle seats. The vehicle seats may be located in a first, second, or third row of a vehicle. The vehicle seats may comprise a frame. The frame may function to structurally reinforce the seat, support cushions, support occupants, or any combination thereof. The frame may be exposed on an underside of the seat. There may be an open space located underneath the seat. The open space may include ambient air. Air employed by the heating module of the present disclosure may be drawn at least from underneath the seat although the present disclosure does not foreclose air being drawn from other portions of the cabin. The seat may comprise a cushion upon which occupants are seated.

The heating module of the present disclosure may be coupled to a frame of the seat. The heating module of the present disclosure may be packaged within a cushion of the seat.

The present disclosure provides for a heating module. The heating module may function to provide heat to the body of a vehicle occupant, draw heat from the body of a vehicle occupant, draw heat from a PCBA, or any combination thereof. Whether providing heat to, or drawing heat from an occupant, these functions will be referred to herein, individually or in combination, as conditioning. The heating module may condition any body part of an occupant. The heating module may condition a head, a torso, or a lower body of an occupant or any combination thereof. The heating module may condition the legs of a vehicle occupant. The heating module may condition the calves, shins, feet, knees, or backs of the knees, of a vehicle occupant or any combination thereof. The small packaging space realized by the heating module of the present teachings may be particularly advantageous in heating modules provided under vehicle seats and adapted to condition the lower body (e.g., legs) of a vehicle occupant.

While the present disclosure may refer to a heating module, it is understood that the module may operate in a mode in which a heating element is not operational, but a fluid movement device is operational. In effect, ambient air may be provided to the occupant to provide cooling by drawing heat from an occupant.

The heating module of the present disclosure may realize a small packaging size. The heating module may have a length of about 180 mm or more, 190 mm or more, 200 mm or more, or even 210 mm or more. The heating module may have a length of about 260 mm or less, 250 mm or less, 240 mm or less, or even 230 mm or less. The heating module may have a width of about 190 mm or more, 200 mm or more, or even 210 mm or more. The heating module may have a width of about 150 mm or less, 140 mm or less, or even 130 mm or less. The heating module may have a height of about 20 mm or more, 30 mm or more, or even 40 mm or more. The heating module may have a height of about 70 mm or less, 60 mm or less, or even 50 mm or less.

The heating module may comprise one or more heating elements, one or more heat exchangers, a fluid moving device, an impeller, a housing, a PCBA portion, a heating module portion, one or more inlets, one or more outlets, one or more conduits, one or more air directing members, a diffuser, a PCBA, a LIN connector, a power connector, one or more heating element connectors, one or more wires, one or more air temperature sensors, or any combination thereof.

The heating module may comprise one or more heating elements. The heating elements may function to generate heat, exchange heat with air, conduct heat to one or more heat exchangers, or any combination thereof.

The heating elements may be fabricated of a resistive material. The material may be provided in the form of a plate, wire, deposited (e.g., printed) lines of material, the like, or any combination thereof. The heating elements may be resistive wire heating elements, ceramic heating elements, thick film heating elements, polymer heating elements, the like, or any combination thereof. The heating elements may be positive temperature coefficient heating elements although other types of electronically powered heating elements are not outside of the scope of the present teachings.

The heating elements may be powered by electricity. The heating elements may be powered via a printed circuit board assembly (“PCBA”) as disclosed herein. The heating element may connect to a PCBA. The heating elements may have a heating capacity of about 250 W or more, 300 W or more, or even 350 W or more. The heating elements may have a heating capacity of about 500 W or less, 450 W or less, or even 400 W or less.

The heating elements may comprise one or more connectors. The heating element connectors may function as a mounting point for one or more wires, to provide electricity to the heating elements, or both. The connectors may comprise a surface to which wires may be attached. The wires may be attached by conductive adhesive, soldering, clips, harnesses, the like, or any combination thereof. The connectors may extend toward a printed circuit board assembly. The connectors may extend into a PCBA portion of a housing, as disclosed herein. The connectors may extend from a heating element portion of a housing, as disclosed herein, into a PCBA portion of a housing.

The heating elements may be located in a conduit of a heating element portion of a housing. The heating elements may be located proximate to an inlet of the heating element portion, proximate to an outlet of the heating element portion, or anywhere therebetween. The heating elements may extend between any two opposing sides of the conduit or any length therebetween.

The heating elements may include one or more, two or more, or even three or more heating elements.

The heating module may comprise one or more heat exchangers. The heat exchangers may function to conduct heat from heating elements and exchange heat with air flowing through the heat exchangers. The heat exchangers may comprise a corrugated material. The heat exchangers may be adapted to provide an airflow therethrough. The heat exchangers may be fabricated from a heat conductive material such as metal. The metal may include steel, copper, brass, aluminum, the like, or any combination thereof.

The heat exchangers may be in contacting relationship with the heating elements. The heat exchangers may be in thermally conductive communication with the heating elements. A heat exchanger may be disposed between heating elements. A heating element may be disposed on just one side of a heat exchanger.

The heating module may comprise one or more fluid moving devices. The fluid moving device may function to uptake air (e.g., ambient air) from a cabin of a vehicle, provide air to heating elements, provide air to a PCBA, provide air to an occupant of a vehicle, or any combination thereof.

The fluid moving device may be a radial fan or axial fan. The fluid moving device may operate at a variable speed. Pulse width modulation (PWM) directed by a PCBA may determine the speed of the fluid moving device. The PCBA may determine the speed by a signal input provided by an air temperature sensor, a setpoint temperature provided by occupants, or both.

The fluid moving device may uptake air from an inlet. The fluid moving device may expel air through one or more outlets. A first outlet may provide air to a heating element portion of a housing. The first outlet may be in fluid communication with a diffuser. A second outlet may provide air to a PCBA portion of a housing. The inlet of the fluid moving device may be oriented downward from the vehicle seat. In other words, the inlet may be oriented toward a floor within the cabin of a vehicle. This arrangement may be advantageous to avoid the uptake of debris.

The orientation of the fluid moving device, heating elements, and/or conduits may be adapted to minimize airflow variation across a surface of the heating element and/or output temperature across an area of the outlet. This may be achieved by providing a conduit with an axial offset from a longitudinal axis extending between a rotational axis of an impeller and a geometrically center point of the body of the heating elements and heat exchangers, a conduit with a cross-sectional area that varies continuously from an inlet of the conduit to an outlet of the conduit, providing one or more air directing members within a conduit, or any combination thereof. The conduit may extend at an angle of about 5° or more, 10° or more, or even 20° or more from the longitudinal axis. The conduit may extend at an angle of about 60° or less, 50° or less, or even 40° from the longitudinal axis. The output temperature variation across the area of the outlet may be about 4° C. or less, more preferably about 2° C. or less, or even more preferably about 1° C. or less.

The fluid moving device may be integrated into the housing. That is, one or more constituent elements of the fluid moving device (e.g., impeller) may be provided within the housing.

The fluid moving device may comprise an impeller. The impeller may function to uptake air, deliver air to one or more heating elements, deliver air to a PCBA, deliver air to an occupant, or any combination thereof. The impeller may fluidly communicate with an inlet. The impeller may fluidly communicate with one or more outlets.

The impeller may rotate about a rotational axis. Such rotation may be effectuated by a motor. The motor may comprise a rotor and stator. The rotor and the impeller may be coupled by a shaft. The rotor and stator may be structurally independent from the heating module. That is, the heating module may be provided as a unitary construction with the impeller disposed within the housing and the rotor, via a shaft, may be removably coupled to the impeller. This arrangement may be particularly advantageous in providing a fluid moving device with a standardized configuration and providing various motors to suit particular end-use applications. By way of example, a required airflow (typically measured in cubic feet per minute) of one application may be less than or greater than a required airflow for a different application. Thus, a different motor may be employed. In providing a fluid moving device in this modular format, manufacturing costs and complexity may be mitigated, and a unitary heating module may be provided to suit a variety of end-use applications.

The heating module may comprise one or more outlets. Outlet may refer to any orifice through which air is expelled and/or supplied to another portion of the heating module or vehicle cabin. The outlets may include a first outlet that supplies air to a heating element portion of a housing and a conduit thereof. The outlets may include a second outlet that supplies air to a PCBA portion of a housing and a conduit thereof. The outlets may include an outlet by which the heating element portion of a housing expels air to a cabin of a vehicle. The outlet of the heating element portion may be associated with a diffuser. The outlets may include an outlet by which the PCBA portion of a housing expels air to a cabin of a vehicle.

The heating module may comprise one or more inlets. Inlet may refer to any orifice through which uptake of air is effectuated and/or air is supplied to another portion of the heating module. The inlets may include an inlet through which an impeller uptakes air from a vehicle cabin. The inlets may include an inlet by which a PCBA portion and a conduit thereof receives air from the impeller. The inlets may include an inlet by which the heating element portion and a conduit thereof receives air from the impeller.

The heating module may comprise a housing. The housing may function to direct an airflow; structurally protect the components of the heating module; protect components of the heating module from dust, debris, and/or moisture; provide structural reinforcement to the heating module; provide the heating module with mounting points for coupling to a vehicle seat; or any combination thereof.

The heating module may conform to an IEC Standard 60529 ingress protection rating. The heating module may be rated for dust protection, dust tightness, dripping water protection, spraying water protection, splashing water protection, or any combination thereof.

The housing may be fabricated from polymer. The polymer may include polyethylene, polypropylene, polyurethane, polyester, polyamide, polyvinylchloride, polyamide, polycarbonate, polymethylmethacrylate, the like, or any combination thereof. The housing may be fabricated by injection molding or co-injection molding.

The housing may comprise one or more segments. Each of the segments may be structurally distinct and may couple together upon assembly. The segments may couple together by fasteners, adhesives, or both. An interface of the segments may generally bisect a width of the heating module. However, the present disclosure contemplates that the interface may be disposed closer to one side or the other of the heating module along the width.

The housing may comprise a first (top) segment, a second (bottom) segment, a third (impeller) segment or any combination thereof. Top may refer to a segment oriented toward the underside of a vehicle seat. Bottom may refer to a segment oriented toward a floor disposed within the cabin of a vehicle. The third (impeller) segment may be oriented toward the underside of a vehicle seat or a floor of the cabin of a vehicle. The present disclosure contemplates a housing comprising only a first (top) segment and a second (bottom) segment. In other words, the third segment may be integrated into the first and/or second segments. Either of the first and second segments may cover an impeller.

The housing may comprise a printed circuit board assembly (PCBA) portion. The PCBA portion may function to house a PCBA, direct an airflow across a PCBA, distance a PCBA from heating elements, or any combination thereof.

The PCBA portion may be provided an airflow that is separate from the airflow provided the heating element portion. The PCBA portion may be discrete from the heating element portion. That is, the PCBA portion may define a volume that is discrete from a volume defined by the heating element portion. The PCBA portion may be structurally attached to the heating element portion by a conduit and segment through which heating element connectors extend. The PCBA portion may be structurally attached to the heating element portion by any adjoining surfaces of the housing. The PCBA portion may be distanced from the heating element portion. In this manner, heat from the heating element may be precluded from conductively and/or convectively migrating to the PCBA.

The PCBA portion may comprise a first side oriented toward the fluid moving device portion and/or heating element portion. The PCBA portion may comprise a second side oriented away from the fluid moving device portion and/or heating element portion. It may be particularly advantageous to provide the PCBA with a side abutting or at least proximal to the first side of the PCBA portion to distance the PCBA the furthest away from the heating elements as possible. The PCBA may be oriented vertically within the PCBA portion. That is, one edge of the PCBA may be oriented toward an underside of a vehicle seat and an opposing edge of the PCBA may be oriented toward a floor of the cabin of a vehicle, in reference to when the heating module is installed in or on a vehicle seat. In this configuration, heat migration from the heating element to the PCBA is mitigated or even eliminated. By way of example, if the printed circuit board assembly were oriented horizontally, then one edge of the printed circuit board assembly may be located proximate to the heating element or at least proximate to portions of the housing that may conduct heat from the heating element.

The PCBA portion may comprise one or more outlets. The outlet may expel air to a vehicle cabin. The direction of the airflow expelling from an outlet of the PCBA portion may oppose the direction of the airflow expelling from an outlet of the heating element portion. The outlet of the PCBA portion may be located on a first end of the heating module that opposes a second end of the heating module where the outlet of the heating element portion may be located.

The housing may comprise one or more conduits. The housing may comprise a conduit that fluidly communicates with a diffuser, a conduit that fluidly communicates with a PCBA portion, or both. The conduit fluidly communicating with the PCBA portion may branch off from the fluid moving device portion. The conduit fluidly communicating with the PCBA portion may extend at an angle relative to a longitudinal axis of the heating module. The angle may be about 30° or more or even 45° or more. The angle may be about 75° or less, or even 90° or less. The conduit of the PCBA portion may extend generally toward an end of the heating module in opposing relationship to an end where the PCBA portion outlet is located. In this manner, air may travel to a closed end of the PCBA portion and then travel back toward the outlet. This arrangement may be advantageous to ensure airflow across the entirety of the PCBA. The conduit of the PCBA portion may extend generally toward an end of the heating module where the heating element portion outlet is located.

The conduit of the heating element portion may extend generally straight from the inlet to the outlet. The conduit of the heating element portion may be free of any bends, turns, or both.

The housing may comprise one or more air directing members. The air directing member may function to mitigate variations of airflow across a surface of the heating elements and/or heat exchangers. The air directing members may be integral to the housing. The air directing members may project from the housing. The air directing members may be oriented generally orthogonal to a surface of the housing. The air directing members may be disposed on a first and/or second segment of the housing. Air directing members of the first segment may be in contacting relationship with air direction members of the second segment.

The heating module may comprise one or more diffusers. The diffuser may function to direct an airflow, diffuse an airflow, prevent access to the heating element, or both. The diffuser may be provided air by one or more outlets of a heating element portion of the housing.

The diffuser may be modular with the housing. The diffuser may be structurally discrete from the housing. The diffuser may be removably coupled to the housing. The diffuser may be coupled to the housing with fasteners, adhesives, or both. The configuration of the diffuser may be selected according to the end-use while the rest of the housing may remain the same. In providing a diffuser in this modular format, manufacturing costs and complexity may be mitigated, and a unitary heating module may be provided to suit a variety of end-use applications. For instance, a diffuser directing airflow in one direction may be required for some applications while a diffuser directing airflow in two directions may be required in other applications.

The diffuser may direct airflow in one or more, two or more, or even three or more directions. By way of example, a diffuser directing airflow in two directions may be suitable to direct airflow to both legs of an occupant.

The diffuser may be generally planar. A generally planar diffuser may direct air in one direction. The diffuser may be generally Y-shaped. The generally Y-shaped diffuser may direct air in two directions. The generally Y-shaped diffuser may have two conduits branching off from a common conduit. The common conduit may couple to an outlet of the housing.

The diffuser may comprise a grille. The grille may extend over the outlet. The grille may function to prevent access to the heating element by objects or persons. The grille may prevent persons from burning themselves on the heating element.

The heating module may comprise one or more printed circuit board assemblies (PCBA). The PCBA may function to power the fluid moving device and/or heating elements, direct the speed of the fluid moving device, direct the temperature of the heating elements, or any combination thereof.

The PCBA may communicate with a vehicle's master controller via LIN signals. The PCBA may be powered by the vehicle battery. The PCBA may comprise a power connector and/or a LIN connector. The power connector and the LIN connector may be provided as separate connectors or a single integrated connector. The heating module may be compliant to LIN 2.1. The heating module may be a LIN slave. The heating module may be able to change software parameters via LIN. The embedded software and EEPROM content may be programmable via LIN.

The PCBA may be disposed within the PCBA portion of the housing.

The heating module may comprise one or more air temperature sensors. The air temperature sensor may function to sense the temperature of ambient air, provide signals to the PCBA, instruct the fluid moving device speed and/or heating element temperature, or any combination thereof.

One or more signals from one or more air temperature sensors may be employed to direct the speed of the fluid moving device and/or the temperature of the one or more heating elements. The air temperature sensor may signally communicate with a PCBA.

The air temperature sensor may be a negative temperature coefficient sensor although other types of air temperature sensors may be within the scope of the present teachings.

The air temperature sensor may protrude from a PCBA portion of the housing. The air temperature sensor may protrude into a space between the PCBA portion, the heating element portion, a conduit extending between the fluid moving device and the inlet of the PCBA portion, or any combination thereof. Thus, the air temperature sensor may be provided protection by the housing.

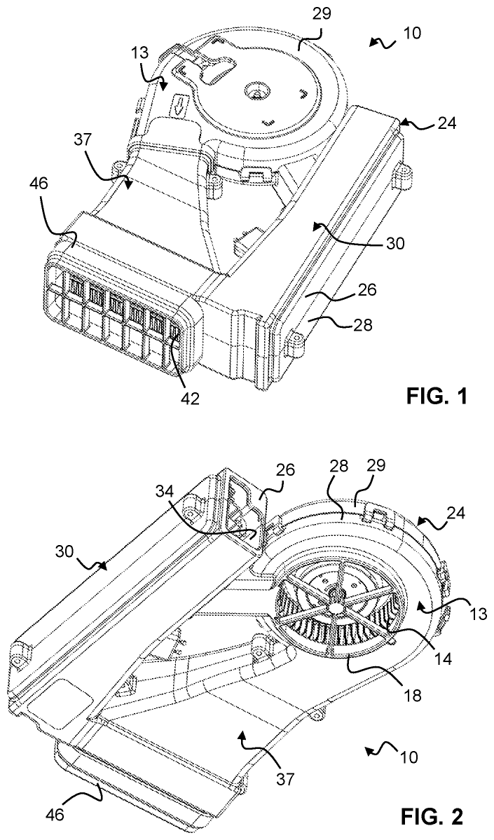

FIG. 1 and FIG. 2 illustrate a perspective view of a heating module 10. The heating module 10 comprises a housing 24 with a fluid moving device portion 13, a PCBA portion 30, and a heating element portion 37. The housing 10 is provided in three structural segments 26, 28, 29.

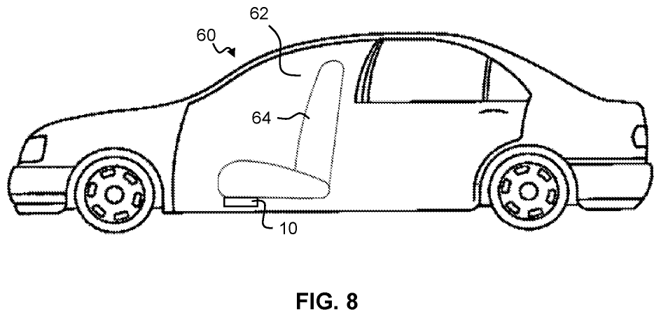

A diffuser 46 is coupled to an outlet 42 of the heating element portion 37. An inlet 18, shown in FIG. 2, is provided in the fluid moving device portion 13. The inlet 18, by the action of an impeller 14, uptakes ambient air from a cabin 62 of a vehicle 60, as shown in FIG. 8. The air is expelled from both the outlet 42 of the heating element portion 37 and an outlet 34 of the PCBA portion 30 shown in FIG. 2.

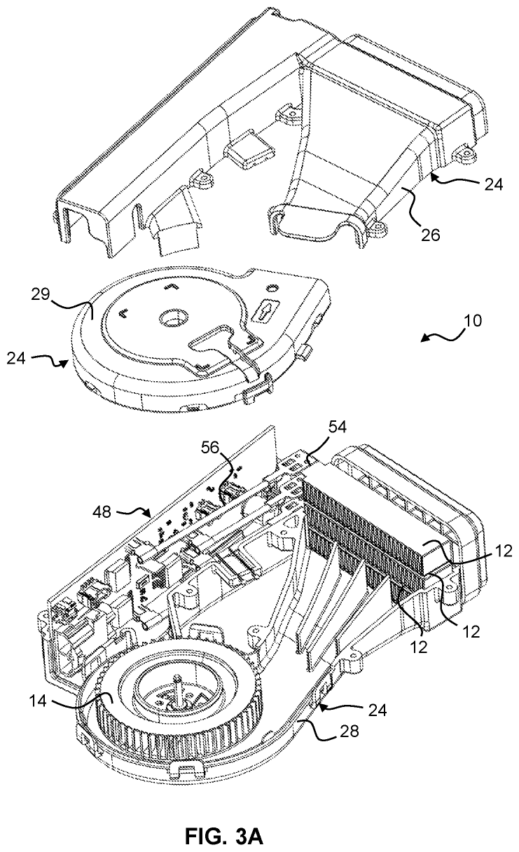

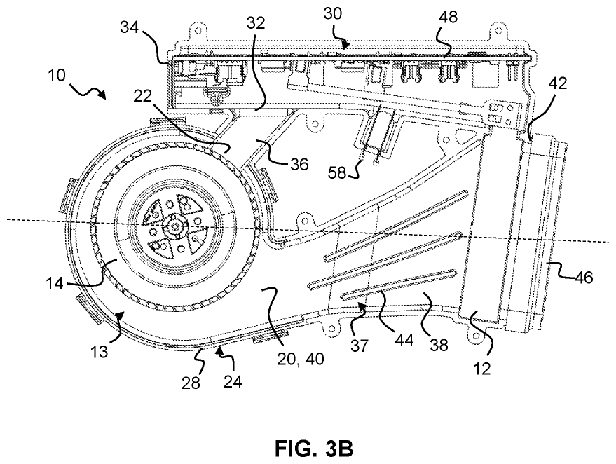

FIG. 3A illustrates an exploded view of a heating module 10. The heating module 10 comprises a housing 24 that is provided in three structural segments 26, 28, 29.

The heating module comprises an impeller 14, which uptakes air through the inlet 18 shown in FIG. 2. The impeller 14 supplies an airflow to heating elements 12 and a printed circuit board assembly 48. The airflow cools the printed circuit board assembly 48 and is supplied heat by the heating elements 12.

The heating elements 12 comprise connectors 54 that extend toward the printed circuit board assembly 48. Wires 56 connect to and extend between the printed circuit board assembly 48 and the connectors 54. The wires 56 supply power to the heating elements 12.

FIG. 3B illustrates a plan view of a heating module 10. The heating module 10 comprises a housing 24 including a fluid moving device portion 13, PCBA portion 30, and heating element portion 37. The fluid moving device portion 13 includes an impeller 14 for the uptake of air and the expulsion of the air to the heating element portion 37 via a first outlet 20 and to the PCBA portion 30 via a second outlet 22.

The air enters an inlet 40 of the heating element portion 37 and travels through a conduit 38 toward heating elements 12 disposed proximate to an outlet 42 of the heating element portion 37. The air then travels through a diffuser 46. Air directing members 44 project from the second segment 28 of the housing 24. Similarly, air directing members 44 project from the first segment 26 of the housing 24 shown in FIG. 3A and the edges thereof come into a contacting relationship with the air directing members 44 of the second segment 28 when the first segment 26 is disposed onto the second segment 28.

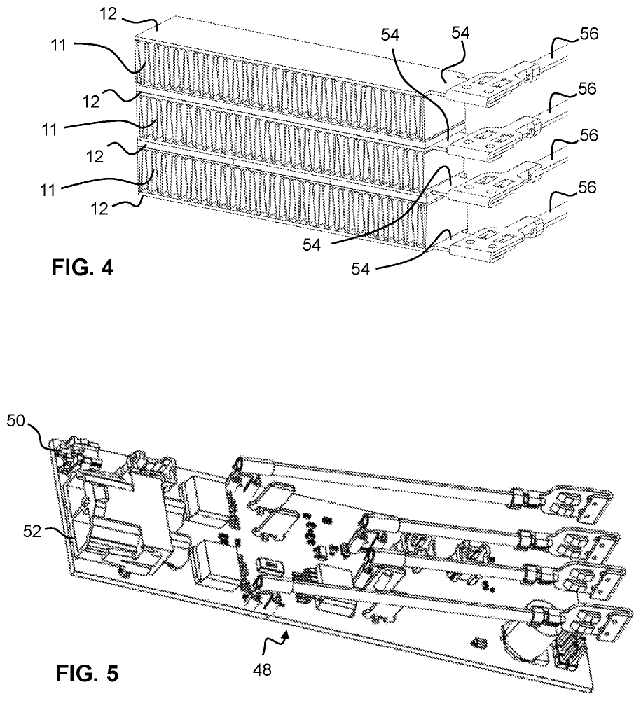

The orientation of the impeller 14, heating elements 12, and/or conduit 38 may be adapted to minimize airflow variation across a surface of the heating elements 12. This may be achieved by providing the conduit 38 with an axial offset from a longitudinal axis (denoted by the dashed line) of the heating module 10 extending between a rotational axis of the impeller 14 and a geometrically center point of the body of the heating elements 12 and heat exchangers 11 shown in FIG. 4, a conduit 38 with a cross-sectional area that varies continuously from an inlet 40 to an outlet 42 (the cross-section being generally perpendicular to the longitudinal axis), providing air directing members 44 within the conduit 38, or any combination thereof. As shown, the conduit is axially offset from the longitudinal axis by about 20°.

The air travels through a conduit 36 extending between the second outlet 22 of the fluid moving device and an inlet 32 of the PCBA portion 30. The air travels through the PCBA portion 30, exchanges heat with a PCBA 48, and is expelled from an outlet 34 of the PCBA portion 30. The PCBA 48 is oriented such that a side of the PCBA 48 is oriented toward the fluid moving device portion 13 and the heating element portion 37. Moreover, the PCBA 48 abuts an inner surface of the PCBA portion 30 that is oriented toward the fluid moving device portion 13 and the heating element portion 37. In this arrangement, the PCBA 48 is distanced from the heating elements 12 to mitigate the PCBA 48 from absorbing heat from the heating elements 12 or portions of the housing 24 proximate to the heating elements 12 that conduct heat from the heating elements 12.

The heating module 10 comprises an air temperature sensor 58. The air temperature sensor 58 protrudes into a space between the PCBA portion 30, the heating element portion 37, and the conduit 36. In this arrangement, the air temperature sensor 58 is physically protected from contact or damage, such as from an object striking the sensor 58. Moreover, the air temperature sensor 58 is provided in a space where an ambient air temperature is representative of the cabin 62 of the vehicle 60 shown in FIG. 8. That is, the sensor 58 is distanced from the heating elements 12 and is surrounded by portions of the housing 24 subjected to airflow by air supplied from the cabin 62.

FIG. 4 illustrates a perspective view of heating elements 12 and heat exchangers 11. The heat exchangers 11 are disposed in between the heating elements 12. Each of the heating elements 12 include connectors 54 to which wires 56 attach via clips. The other end of the wires 56 attach to a PCBA 48 shown in FIG. 5. The heat exchangers 11 comprise corrugated material providing for airflow through the heat exchangers 11.

FIG. 5 illustrates a perspective view of a PCBA 48. The PCBA 48 comprises a LIN connector 50 and a power connector 52, which, when installed in a PCBA portion 30, are disposed proximate to the outlet 34 of the PCBA portion 30 shown in FIG. 3B.

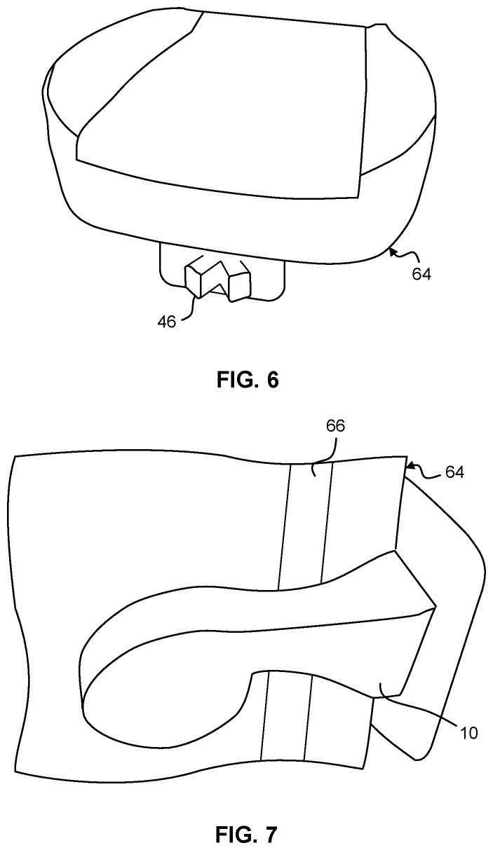

FIG. 6 illustrates a perspective view of a vehicle seat 64. A heating module 10 shown in FIG. 7 is coupled to an underside of the vehicle seat 64. A diffuser 46 is exposed toward the front of the vehicle seat 64.

FIG. 7 shows a heating module 10 coupled to an underside of a vehicle seat 64. The heating module 10 is coupled to a frame 66 of the vehicle seat 64.

FIG. 8 illustrates a vehicle 60. The vehicle 60 defines a cabin 62, within which a vehicle seat 64 is located. A heating module 10 is provided on an underside of the vehicle seat 64.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Many embodiments as well as many applications besides the examples provided will be apparent to those of skill in the art upon reading the above description.

It is understood that the above description is intended to be illustrative and not restrictive. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled.

The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Other combinations are also possible as will be gleaned from the following claims, which are also hereby incorporated by reference into this written description.

Plural elements or steps can be provided by a single integrated element or step. Alternatively, a single element or step might be divided into separate plural elements or steps. The disclosure of “a” or “one” to describe an element or step is not intended to foreclose additional elements or steps.

While the terms first, second, third, etc., may be used herein to describe various elements, components, regions, layers, and/or sections, these elements, components, regions, layers, and/or sections should not be limited by these terms. These terms may be used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed herein could be termed a second element, component, region, layer, or section without departing from the teachings.

Spatially relative terms, such as “inner”, “outer”, “beneath”, “below”, “lower”, “above”, “upper”, and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.100 or greater, or even about +/−0.5% or greater.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time, and the like is, for example, from 1 to 90, from 20 to 80, or from 30 to 70, it is intended that intermediate range values such as (e.g., 15 to 85, 22 to 68, 43 to 51, 30 to 32, etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

What is claimed is:

1: A heating module comprising:
a housing comprising a printed circuit board assembly portion and a heating element portion,
a printed circuit board assembly located within the printed circuit board assembly portion, and
one or more heating elements located within the heating element portion; and
wherein an airflow is provided to the printed circuit board assembly portion by a fluid moving device to draw heat from the printed circuit board assembly.

2: The heating module according to claim 1, wherein the airflow provided to the printed circuit board assembly portion is separate from an airflow provided to the heating element portion.

3: The heating module according to claim 2, wherein the housing comprises a conduit extending between the fluid moving device and an inlet of the printed circuit board assembly portion.

4: The heating module according to claim 3, wherein a direction of the airflow expelling from an outlet of the printed circuit board assembly portion opposes a direction of the airflow expelling from an outlet of the heating element portion.

5: The heating module according to claim 4, wherein the outlet of the printed circuit board assembly portion is located on a first end of the heating module that opposes a second end of the heating module where the outlet of the heating element portion is located.

6: The heating module according to claim 5, wherein the printed circuit board assembly comprises a first side and a second side in opposing relationship to one another; wherein the first side is oriented toward the fluid moving device and the one or more heating elements; and wherein the second size of the printed circuit board assembly is abutting or proximate to an inner surface of the printed circuit board assembly portion that is oriented toward the fluid moving device and one or more heating elements.

7. (canceled)

8: The heating module according to claim 1, wherein the heating module comprises an air temperature sensor for measuring ambient air in a cabin of a vehicle; and
wherein a signal from the air temperature sensor is employed to direct a speed of the fluid moving device, a temperature of the one or more heating elements, or both.

9: The heating module according to claim 8, wherein the air temperature sensor is a negative temperature coefficient sensor.

10: The heating module according to claim 9, wherein the air temperature sensor protrudes from printed circuit board assembly portion of the housing.

11: The heating module according to claim 10, wherein the air temperature sensor protrudes into a space between the printed circuit board assembly portion, the heating element portion, a conduit extending between the fluid moving device and an inlet of the printed circuit board assembly portion, or any combination thereof.

12: The heating module according to claim 6, wherein the one or more heating elements are positive temperature coefficient heating elements.

13: The heating module according to claim 12, wherein connectors of the one or more heating elements extend into the printed circuit board assembly portion; and wherein wiring extends from the connectors to the printed circuit board assembly.

14: The heating module according to claim 13, wherein the fluid moving device is integrated into the housing.

15: A vehicle comprising the heating module according to claim 1.

16: The vehicle according to claim 15, wherein the vehicle is a hybrid vehicle or a fully electric vehicle.

17: A vehicle seat comprising the heating module according to claim 1.

18: The vehicle seat according to claim 17, wherein the vehicle seat is located in a first, a second, and/or a third row of a vehicle.

19: The vehicle seat according to claim 18, wherein the heating module is adapted to effectuate an airflow upon an occupant's legs.

20: The vehicle seat according to claim 19, wherein an inlet of the fluid moving device is oriented downward from the vehicle seat.

21: The vehicle seat according to claim 20, wherein the heating module is secured to a frame of the vehicle seat or is packaged within a cushion of the vehicle seat.

22. (canceled)
